(19) United States
(12) Patent Application Publication
(10) Pub. No.: US 2015/0088424 A1
(43) Pub. Date: Mar. 26, 2015

(54) IDENTIFYING GEOLOGICAL FORMATION DEPTH STRUCTURE USING WELL LOG DATA

(71) Applicant: Schlumberger Technology Corporation, Sugar Land, TX (US)

(72) Inventors: Nikita Sergeyevich Burlakov, Moscow (RU); Sergio Fabio Courtade, Heggedal (NO); Sergey Nikolayevich Skripkin, Kjeller (NO)

(73) Assignee: Schlumberger Technology Corporation, Sugar Land, TX (US)

(21) Appl. No.: 14/032,267

(22) Filed: Sep. 20, 2013

(51) Int. Cl. G01V 99/00

(52) U.S. Cl. CPC G01V 99/00
USPC 702/6

(57) ABSTRACT

A method for performing a field operation of a field having a subterranean formation. The method includes analyzing, by a computer processor, a plurality of training well logs of a plurality of training wells in the field to generate a plurality of training well markers, wherein the plurality of training well markers identify where the plurality of training wells intercept a plurality of geologic interval boundaries in the subterranean formation, propagating, by the computer processor and onto a target well log of a target well in the field, the plurality of training well markers to generate a plurality of target well markers, wherein the plurality of target well markers identify where the target well intercepts the plurality of geologic interval boundaries, and performing the field operation based at least on identifying where the target well intercepts the plurality of geologic interval boundaries.

### BACKGROUND

Operations, such as geophysical surveying, drilling, logging, well completion, and production, are typically performed to locate and gather valuable downhole fluids. Surveys are often performed using acquisition methodologies, such as seismic mapping, resistivity mapping, etc. to generate images of underground formations. These formations are often analyzed to determine the presence of subterranean assets, such as valuable fluids or minerals, or to determine if the formations have characteristics suitable for storing fluids. Although the subterranean assets are not limited to hydrocarbons such as oil, throughout this document, the terms “oilfield” and “oilfield operation” may be used interchangeably with the terms “field” and “field operation” to refer to a site where any type of valuable fluids or minerals can be found and the activities required to extract them. The terms may also refer to sites where substances are deposited or stored by injecting them into the surface using boreholes and the operations associated with this process. Further, the term “wellbore operation” refers to a field operation associated with a wellbore, including activities related to wellbore planning, wellbore drilling, wellbore completion, and/or production using the wellbore.

Subsurface rock layers are generally referred to as rock strata. A formation consists of a succession of rock strata, typically along a depth scale, with comparable lithology or other similar properties (e.g., color, fossil content, age, chemical composition, physical properties, etc.). The term “formation” may also refer to a group of rocks within a depth range in a drilled well. Collecting well log data from boreholes drilled in the earth provides information which may be analyzed for subsurface formation depth structure within oil or gas fields. The information derived indicates the type of rock in the subsurface and may be used to identify boundaries of geologic intervals in the formation depth structure. Geological intervals are layers of rock structure estimated to have the same geological age. Depending on the context, the term “geological interval” may also refer to the intersection between the geological layer and wellbore. Identifiable boundaries of geologic intervals are referred to as geologic markers or geologic tops. Nuclear, gamma ray, electromagnetic, sonic, magnetic, or other source instrumentation is lowered into the boreholes to generate source signals which probe the underground formations. The formations or geologic tops modify or respond to the source signals, and sensors are disposed with the source instrumentation in the boreholes to monitor the resulting or modified response signals. The response signal characteristics, for example, its amplitude, vary with the different types of source signals and will also depend on the type of formation or geologic top observed. This data is collected over time and is collectively called “well log curves” or “well logs.” The well logs are typically recorded as a function of depth in the boreholes, one recorded curve (or trace) for each type of source.

Multiple boreholes may be used to collect data from multiple wells. Probing multiple wells makes it possible to track spatially the various formations or geologic tops under test. Wells, for example, dozens of wells, may be bored at spacings miles apart for such analysis. Thousands of wells may be bored in more detailed studies, each of which is spaced from one-quarter to one-half mile apart. Boring to a typical depth of 10,000 feet allows multiple formations to be observed in the response traces. The geoscientist's challenge is to map the location of the subsurface formations from multiple numbers of well logs. This may involve trying to match features in traces recorded from one well log to similar features in traces from other (e.g., many other) well logs, a process called correlation. The interpretation of geologic tops in oil or gas fields, however, may be a difficult and time consuming activity. Geologic correlation workflow is frequently used in a number of activities. such as mining, oil and gas exploration and production, geothermal development, water extraction, CO₂ sequestration, geologic engineering, waste management, etc.

### SUMMARY

In general, in one aspect, the invention relates to a method for performing a field operation of a field having a subterranean formation. The method includes analyzing, by a computer processor, a plurality of training well logs of a plurality of training wells in the field to generate a plurality of training well markers, wherein the plurality of training well markers identify where the plurality of training wells intercept a plurality of geologic interval boundaries in the subterranean formation, propagating, by the computer processor and onto a target well log of a target well in the field, the plurality of training well markers to generate a plurality of target well markers, wherein the plurality of target well markers identify where the target well intercepts the plurality of geologic interval boundaries, and performing the field operation based at least on identifying where the target well intercepts the plurality of geologic interval boundaries.

Other aspects of identifying geological formation depth structure using well log data will be apparent from the following description and the appended claims.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The appended drawings illustrate several embodiments of identifying geological formation depth structure using well log data and are not to be considered limiting of its scope, for identifying geological formation depth structure using well log data may admit to other equally effective embodiments.

FIG. 1 depicts a schematic cross-sectional view of an earth formation where embodiments of identifying geological formation depth structure using well log data may be practiced.

FIGS. 2.1, 2.1, and 2.3 depict an example method for identifying geological formation depth structure using well log data in accordance with one or more embodiments.

FIGS. 3.1, 3.2, 3.3, 3.4, and 3.5 depict an example of identifying geological formation depth structure using well log data in accordance with one or more embodiments.

FIG. 4 depicts a computer system for identifying geological formation depth structure using well log data in accordance with one or more embodiments.

### DETAILED DESCRIPTION

Embodiments are shown in the above-identified drawings and described below. In describing the embodiments, like or identical reference numerals are used to identify common or similar elements. The drawings are not necessarily to scale and certain features may be shown exaggerated in scale or in schematic in the interest of clarity and conciseness.

Embodiments of the present disclosure include a method, system, apparatus, and computer readable medium for identifying geological formation depth structure using well log data. In one or more embodiments, the correlation workflow involves (i) collecting geological information at each location of the region of interest, (ii) determining key wells (referred to as training wells) from the collected information, (iii) determining geologic intervals and their limits (referred to as training well markers) based on the type and number of geological boundaries to be correlated, (iv) correlating between the training wells and from them to other drilled well in the region of interest, and (v) identifying any missing or duplicative intervals. In one or more embodiments, correlating between training wells and other drilled wells involves an analysis of the similarity between sections of well logs at different locations. In particular, the well log sections correspond to geologic records associated with different geologic intervals. For example, the geologic intervals may correspond to sedimentary depositions that have occurred over time that are intersected by the wellbore. Accordingly, the similarity corresponds to geologic equivalence between the different locations.

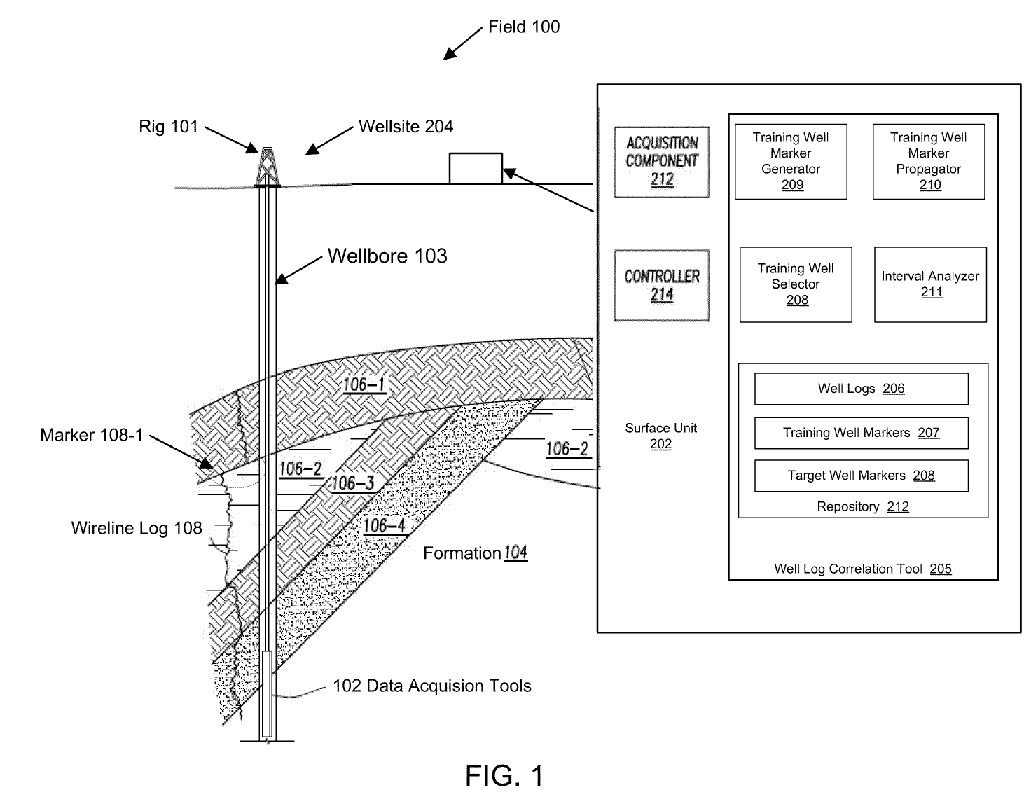

FIG. 1 depicts a schematic view, partially in cross section of a field (105) where identifying geological formation depth structure using well log data related to a subterranean formation (104) may be practiced. In one or more embodiments, one or more of the modules and elements shown in FIG. 1 may be omitted, repeated, and/or substituted. Accordingly, embodiments of identifying geological formation depth structure using well log data should not be considered limited to the specific arrangements of modules shown in FIG. 1.

As shown in FIG. 1, the subterranean formation (104) includes several geological structures (106-1 through 106-4). As shown, the formation has a sandstone layer (106-1), a limestone layer (106-2), a shale layer (106-3), and a sand layer (106-4). In one or more embodiments, various data acquisition tools are adapted to measure the formation and detect the characteristics of the geological structures of the formation.

Further as shown in FIG. 1, the field (100) includes a surface unit (202) operatively connected to a wellsite (204). Generally, the wellsite (204) may include various field tools and wellsite facilities. In one or more embodiments, the wellsite (204) may be associated with a rig (101), a wellbore (103), and other wellsite equipment and is configured to perform oilfield operations, such as logging, drilling, fracturing, production, or other applicable operations. These oilfield operations are typically performed as directed by the surface unit (202). In one or more embodiments, the surface unit (202) is configured to communicate with the data acquisition tool (102) to send commands to the data acquisition tool (102) and to receive data therefrom. The data acquisition tool (102) may be adapted for measuring downhole properties using measurements-while-drilling (MWD) tools, logging-while-drilling (LWD) tools, wireline logging tools, any other similar types of logging measurement tools, or any combination thereof. The surface unit (202) may be provided with computer facilities for receiving, storing, processing, and/or analyzing data from the data acquisition tool (102) or other part of the field (104).

In one or more embodiments, the surface unit (202) may be located at the wellsite (204) and/or remote locations. For example, the surface unit (202) may be associated with a large number of wells in different locations. In one or more embodiments, the surface unit (202) is provided with an acquisition component (212), a controller (214), and a well log correlation tool (205).

In one or more embodiments, the surface unit (202) includes an acquisition component (212) that is configured to collect and/or store data of the field. In one or more embodiments, the acquisition component (212) collects a wide variety of data. The data may be collected from a variety of channels that provide a certain type of data, such as well logs and other acoustic measurement profiles. For example, the data may be collected at the wellsite (204) using the measurements-while-drilling (MWD) tools, logging-while-drilling (LWD) tools, wireline logging tools, any other similar types of logging measurement tools, or any combination thereof. More specifically, the MWD tools, LWD tools, and/or wireline logging tools may be configured to obtain information related to porosity, saturation, permeability, natural fractures, stress magnitude and horizontal orientations, and/or elastic properties of the formation during a drilling, fracturing, or logging operation of the wellbore at the wellsite (204).

For example, a wireline log (108) is a measurement of a formation property as a function of depth taken by an electrically powered instrument to infer properties and make decisions about drilling and production operations. The record of the measurements, typically on a long strip of paper, may also be referred to as a log, or a well log. For example, the measurement records may be obtained using the aforementioned nuclear, gamma ray, electromagnetic, sonic, magnetic, or other source instrumentation.

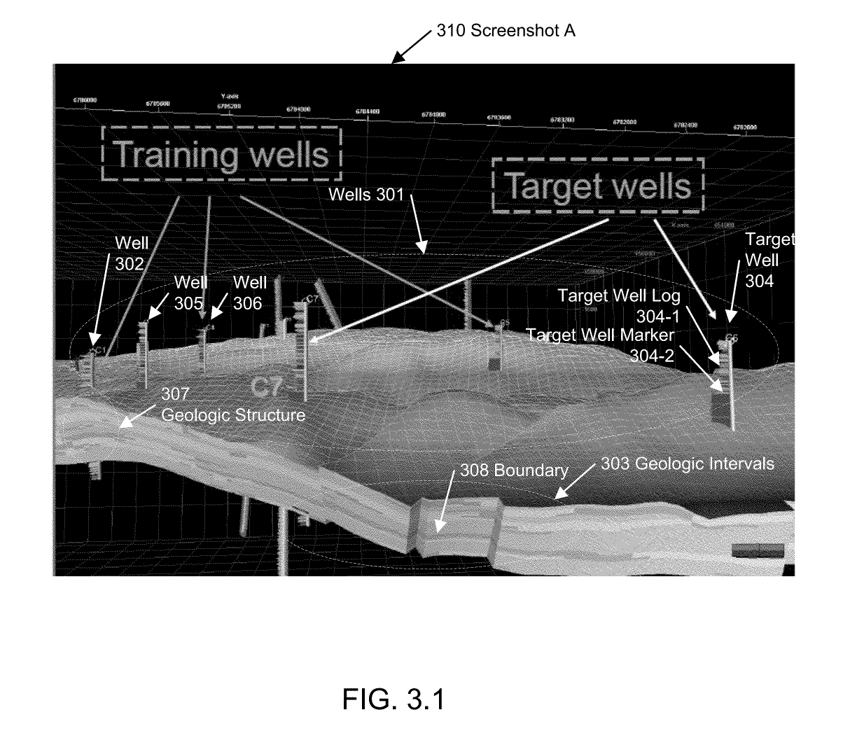

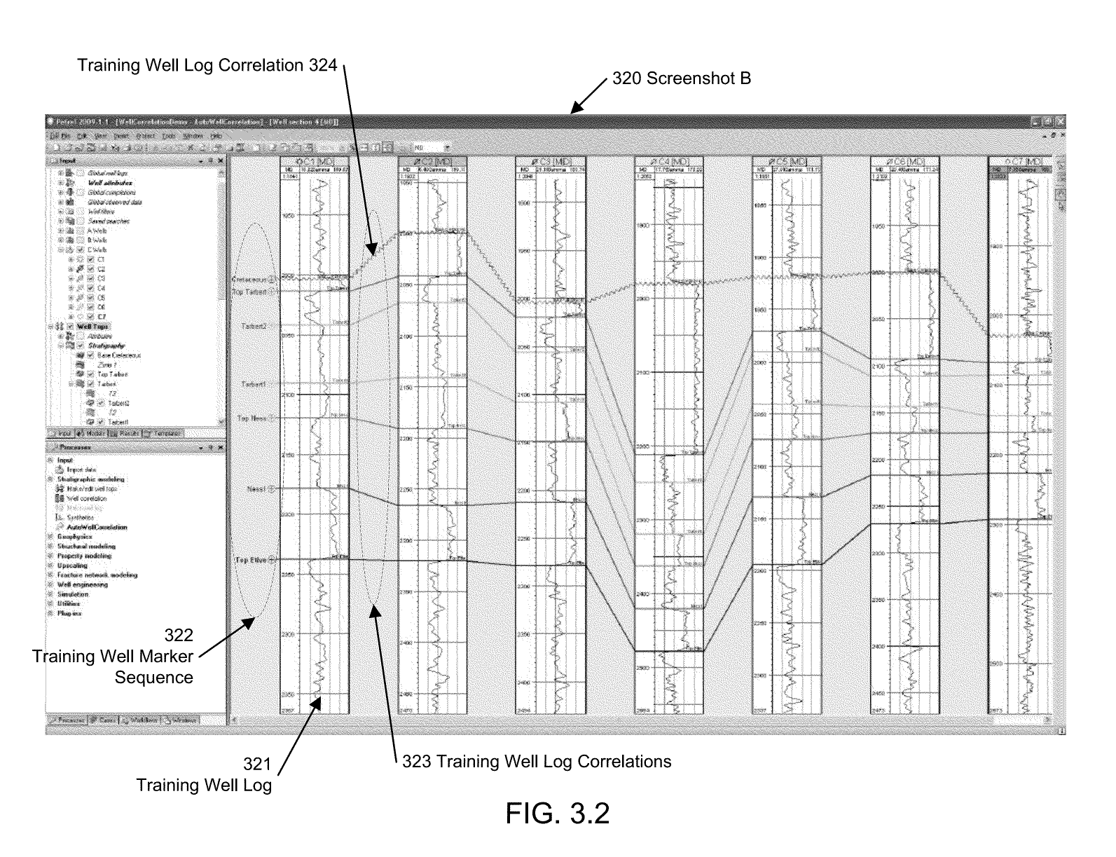

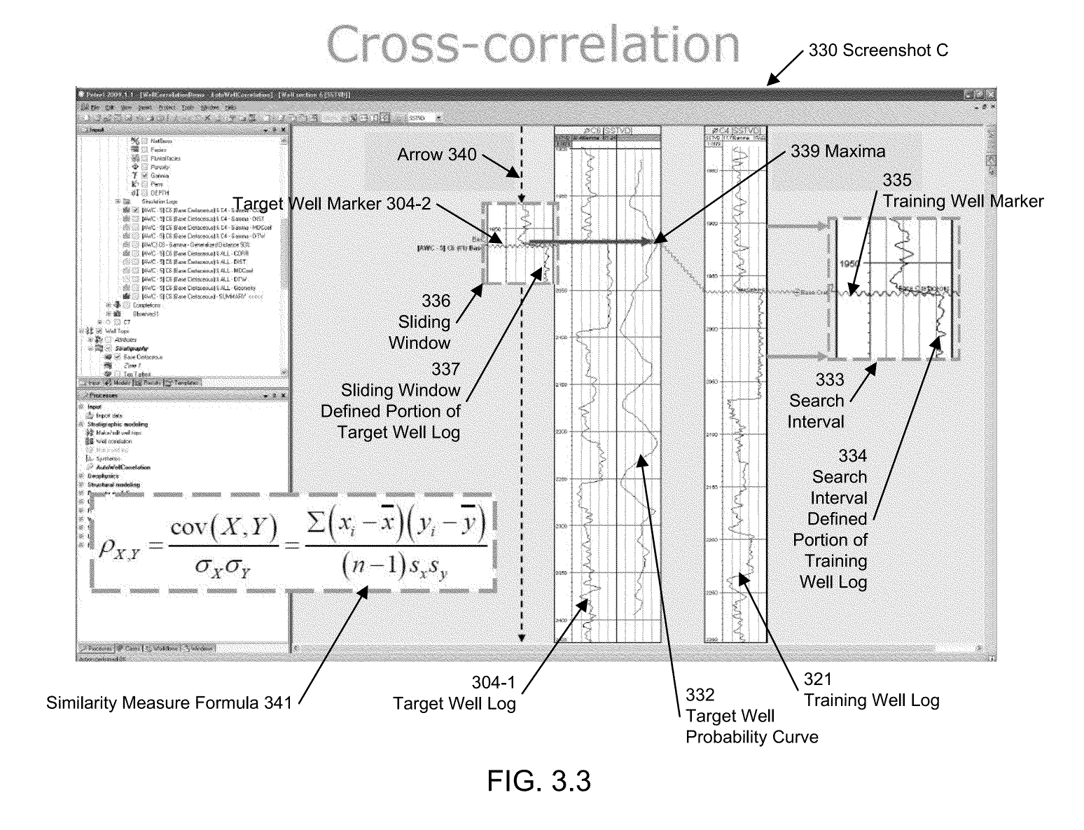

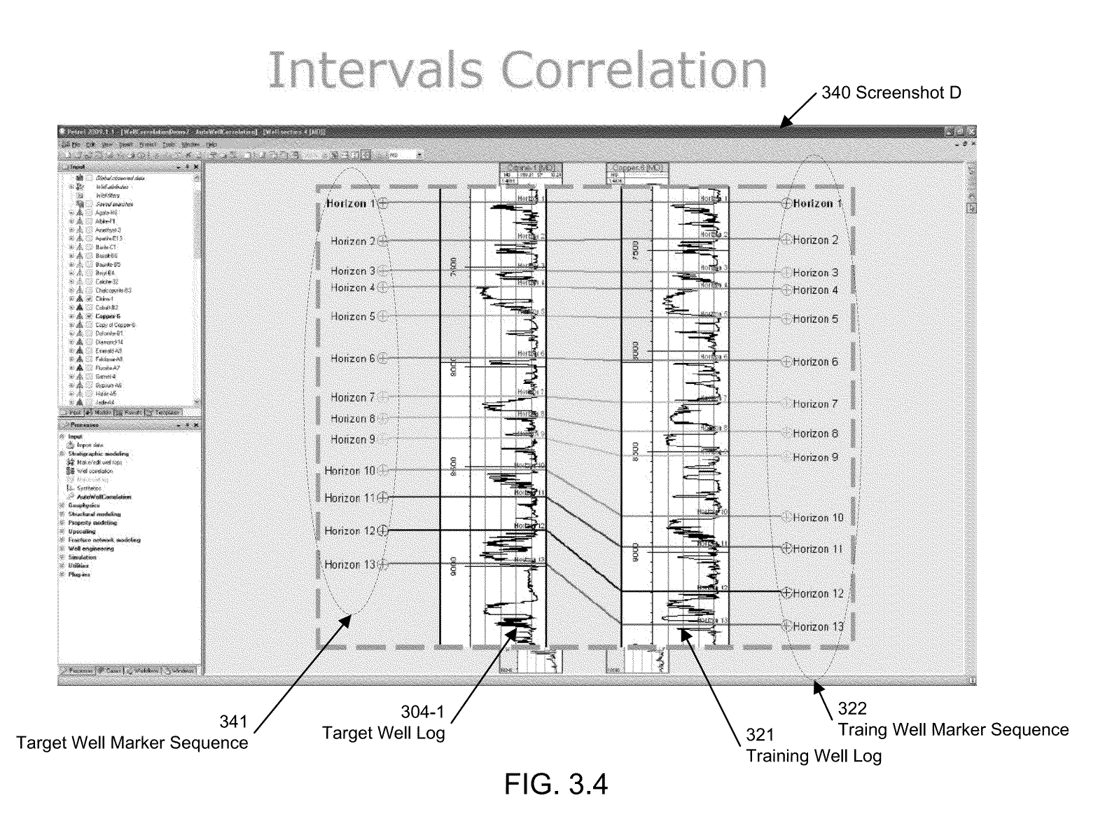

Although many (e.g., hundreds) wells with associated well logs are typically present in a field, only a single well with a single well log is explicitly shown in the field (105) for clarity of illustration. FIG. 3.1 shows an example screenshot A (310) depicting multiple wells (301) associated with multiple well logs containing geologic records of a succession of geologic intervals (302). For example, the screenshot A (310) may be based on measurements obtained from the field (105) of FIG. 1. In particular, the well (302) may correspond to the wellbore (103) and wireline log (108) shown in FIG. 1. In addition, the geologic intervals (303) correspond to the geologic structures (106-1) through (106-4) shown in FIG. 1. As shown in FIG. 3.1, some of the wells (e.g., well (302)) are identified as training wells while the remainder of the wells (e.g., well (304)) are considered target wells.

Returning to the discussion of FIG. 1, in one or more embodiments, the data from the acquisition component (212) includes a large number of well logs (e.g., well logs depicted in FIG. 3.1 and stored as well logs (206)) that are passed to the well log correlation tool (205) for processing. In one or more embodiments, the well log correlation tool (205) includes a training well selector (208) that is configured to select some of the wells (e.g., well (302) among the wells (301)) in the field (105) as training wells based on weights assigned to these wells. In one or more embodiments, the weight assigned to a particular well is based on a distance from the particular well to one or more adjacent wells. For example, the wells (301) may be partitioned using a pre-determined clustering algorithm based on inter-well distances where a densely populated well cluster is identified for selecting training wells therefrom. As illustrated in FIG. 3.1, the wells (302), (305), and (306) are closely spaced to form a densely populated well cluster and are assigned higher weights. In one or more embodiments, the weight assigned to a particular well is based on a distance from the particular well to a particular geological structure. As illustrated in FIG. 3.1, the well (302) is assigned a further higher weight based on its proximity to the geologic structure (307) and is selected as one of the training wells.

Returning to the discussion of FIG. 1, in one or more embodiments, the well log correlation tool (205) includes a training well marker generator (209) that is configured to analyze the training well logs of the selected training wells in the field (105) to generate training well markers (207). Specifically, the training well markers identify where these training wells intercept geologic interval boundaries in the formation (104). For example, the wellbore (103) and the wireline log (108) correspond to the selected training well (302) of FIG. 3.1 and are analyzed to generate the marker (108-1) (e.g., as one of the training well markers (207)). In particular, the marker (108-1) identifies where the wellbore (103) intercepts the geologic interval boundary between the aforementioned sandstone layer (106-1) and limestone layer (106-2). This geologic interval boundary separating the sandstone and limestone layers may correspond to a boundary (308) of the geologic intervals (303), as illustrated in FIG. 3.1.

Returning to the discussion of FIG. 1, in one or more embodiments, the well log correlation tool (205) includes a training well marker propagator (210) that is configured to propagate the training well markers (207), onto a target well log (200) of a target well in the field (105), to generate the target well markers (208). For example, the marker (108-1) of the wireline log (108) may be one of the training well markers (207). The marker (108-1) may correspond to, as illustrated in FIG. 3.1, where the well (302) intercept the boundary (308) and may be propagated onto a target well log (304-1) of the target well (304) to generate a target well marker (304-2). Specifically, the target well marker (304-2) identifies on the target well log (304-1) where the target well (304) intercept the boundary (308). In addition, the target well marker (304-2) may be one of the target well markers (208) shown in FIG. 1.

Returning to the discussion of FIG. 1, in one or more embodiments, the well log correlation tool (205) includes an interval analyzer (211) that is configured to identify any missing or duplicative intervals. In one or more embodiments, the interval analyzer (211) is configured to (i) identify target well intervals in the target well log based on the target well markers, (ii) correlate the target intervals and training well intervals in at least one training well to identify a missing target well interval or a duplicative target well interval, and (iii) in response to the correlating, adjust target well markers to eliminate the missing target well interval or the duplicative target well interval.

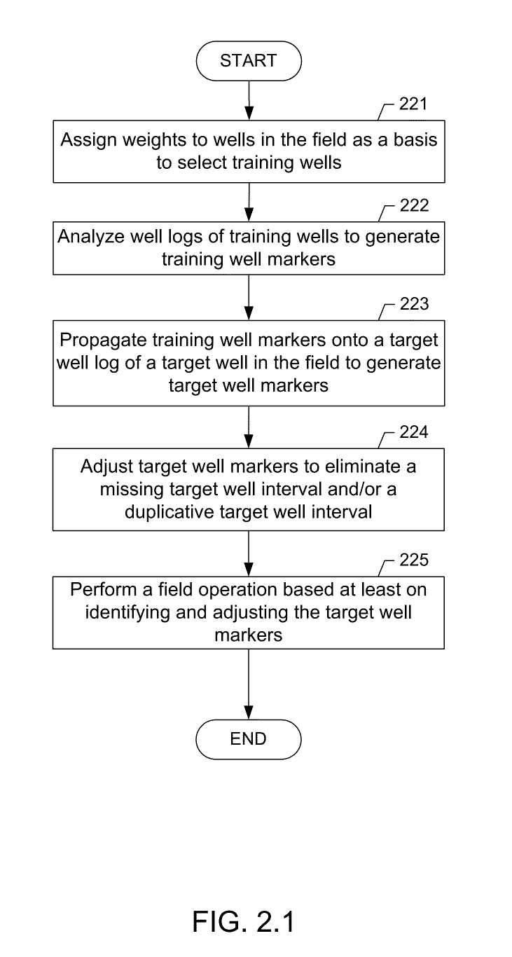

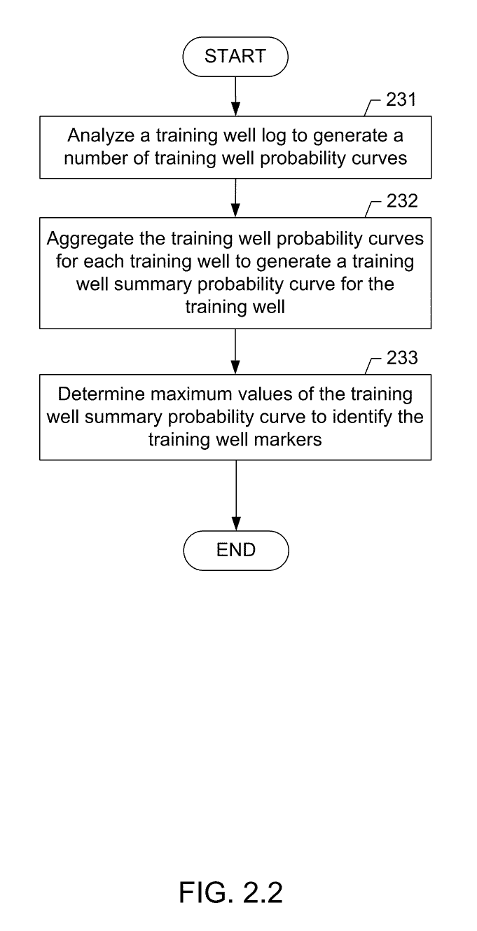

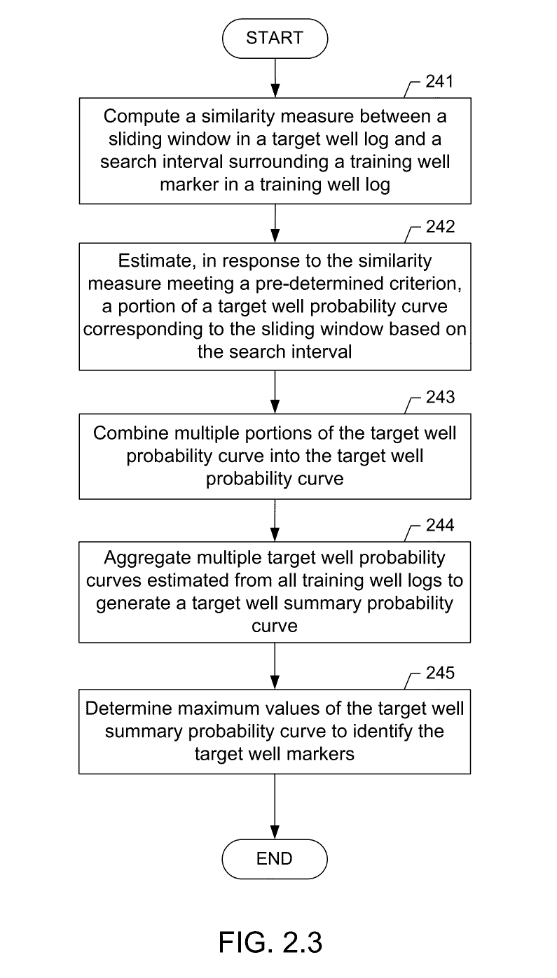

In one or more embodiments, the well log correlation tool (205) includes the data repository (212) that is configured to store data (e.g., the well logs (206) of the training wells and the target wells, the training well markers (207), and the target well markers (208), etc.) for the well log correlation tool (205). In one or more embodiments, the data is organized in a file system, database, or other suitable data structures. Additional details of using the well log correlation tool (205) to automatically select the training well, generating the training well markers, and propagating the training well markers are described in reference to the method flow charts of FIGS. 2.1-2.3 and the example screenshots of FIGS. 3.1-3.5 below.

In one or more embodiments, the surface unit (202) includes the controller (214) that is configured to enact commands at the field (105). The controller (214) may be provided with actuation elements coupled to the wellbore (103) and configured to perform drilling operations, such as steering, advancing, etc., or otherwise taking action for other operations, such as fracturing, production, etc. at the wellsite (204). Commands may be generated based on field data and/or models described above, such as identifying where the target well intercepts the geologic interval boundaries.

While specific components are depicted and/or described for use in the modules of the surface unit (202), it will be appreciated that a variety of components with various functions may be configured to provide the formatting, processing, utility, and coordination functions necessary to process data in the well log correlation tool (205). The components may have combined functionalities and may be implemented as software, hardware, firmware, or suitable combinations thereof.

While a specific subterranean formation (104) with specific geological structures is described above, it will be appreciated that the formation may contain a variety of geological structures. Fluid, rock, water, oil, gas, and other geomaterials may also be present in various portions of the formation. Further, one or more types of measurement may be taken at one or more locations across one or more fields or other locations for comparison and/or analysis using one or more acquisition tools.

FIGS. 2.1, 2.2, and 2.3 depict an example method for identifying geological formation depth structure using well log data in accordance with one or more embodiments. For example, the method depicted in FIGS. 2.1, 2.2, and 2.3 may be practiced using the well log correlation tool (205) described in reference to FIG. 1 above. In one or more embodiments, one or more of the elements shown in FIGS. 2.1, 2.2, and 2.3 may be omitted, repeated, and/or performed in a different order. Accordingly, embodiments of identifying geological formation depth structure using well log data should not be considered limited to the specific arrangements of elements shown in FIGS. 2.1, 2.2, and 2.3.

FIG. 2.1 depicts an example method for identifying geological formation depth structure using well log data in accordance with one or more embodiments. Specifically, the identifying geological formation depth structure using well log data includes automatically selecting training wells, generating training well markers, and propagating training well markers to generate target well markers.

Initially in Step 221, weights are assigned to wells in the field as a basis to select training wells. In one or more embodiments, a particular well is assigned a weight that is based on a distance from the particular well to an adjacent well. For example, the weight may be inversely proportional to the distance and/or inversely proportional to the number of adjacent wells within a range. Based on the assigned weights, the wells in the field may be partitioned into clusters where wells in a densely populated cluster are typically assigned higher weights. In particular, closely spaced wells are considered more effective to be used as training wells. In one or more embodiments, a particular well is assigned a weight that is based on a distance from the particular well to a geological structure of interest. In particular, wells adjacent to the geological structure of interest are considered more effective to be used as training wells. In one or more embodiments, a particular well is assigned a weight that is based on a number of geological markers already identified for the particular well. In particular, wells that have a higher number of already identified geological markers are considered more effective to be used as training wells.

In one or more embodiments, training wells are selected based on the assigned weights. For example, any well assigned a weight exceeding a pre-determined threshold is selected as a training well. In another example, wells with assigned weights in a pre-determined top percentile are selected as training wells.

In Step 222, well logs of the selected training wells are analyzed to generate training well markers. In one or more embodiments, training well markers identify where the training wells intercept geologic interval boundaries in the subterranean formation of the field. For example, the geologic interval boundaries may correspond to sedimentary layers deposited over time. In one or more embodiments, training well markers are generated using the method described in reference to FIG. 2.2 below. As noted above, some training well may already have pre-identified geological markers that are included as an initial portion of the training well markers. For such training well, additional training well markers may be generated using the method described in reference to FIG. 2.2 below.

In Step 223, the training well markers are propagated onto a target well log of a target well in the field to generate target well markers. Specifically, the target well markers identify where the target well intercepts the same geologic interval boundaries identified by the training well markers. In one or more embodiments, the target well markers are generated using the method described in reference to FIG. 2.3 below.

In Step 224, a missing target well interval and/or a duplicative target well interval are identified and eliminated. In one or more embodiments, target well intervals are first identified in the target well log based on the target well markers. These target intervals are then correlated to training well intervals in at least one training well to identify an anomaly, such as a missing target well interval and/or a duplicated target well interval. In response to the correlating, the target well markers are adjusted to eliminate the anomaly. For example, additional target well markers may be added to insert the missing target well interval. In another example, duplicative target well markers may be removed to eliminate the duplicative target well interval. An example of identifying and eliminating a missing target well interval and/or a duplicative target well interval is described in reference to FIG. 3.5 below.

In Step 225, a field operation is performed based at least on identifying and/or adjusting the target well markers. For example, a fracturing operation or other production operation may be performed based on the identified depths where the target well intercepts one or more geologic interval boundaries, such as a boundary between sandstone and limestone layers.

FIG. 2.2 depicts an example method for automatically generating training well markers in accordance with one or more embodiments. In one or more embodiments, the training well markers include stratigraphic markers identifying locations of stratigraphic sequence (i.e., a chronologic succession of sedimentary rocks) boundaries. In one or more embodiments, the training well markers are generated based on a per-training-well basis. In one or more embodiments, the training well markers are generated using a number of marker detection algorithms through the well logs of multiple training wells. Specifically, each marker detection algorithm is used to generate a probability curve for a marker being in place. Accordingly, probability curves generated using these marker detection algorithms are summarized where the maximum probability values identify the training well markers.

Initially in Step 231, a training well log is analyzed to generate a number of training well probability curves. Specifically, each training well probability curve estimates a probability of a sequence boundary occurring at a location along a training well trajectory of the training well. In one or more embodiments, each training well probability curve is generated using one of several pre-determined algorithms. In other words, different algorithms are applied to generate different probability curves. In one or more embodiments, a set of training well probability curves is generated for each of the training wells using these algorithms. In one or more embodiments, these algorithms include the following:

(i) Moving window statistics, which is based on the difference of math expectation values of top and bottom parts of a search window along the training well trajectory. As a search window (e.g., defined by a pre-determined vertical thickness) is stepped through the training well trajectory, the measure

$${D}^{2} = \frac{{( {ME}_{1} - {ME}_{2} )}^{2}}{{Var}_{1} + {Var}_{2}}$$

is calculated for a particular point (e.g., the mid-point, or other pre-determined position) in the search window, where ME₁ and ME₂ represent signal average values in the well log corresponding to the beginning and the end, respectively, of the search window, and Var₁ and Var₂ represent signal variances in the well log corresponding to the beginning and the end, respectively, of the search window. In one or more embodiments, the probability of a training well marker existing at this particular point in the search window is proportional to the measure D². In other words, the larger the difference of math expectation values of top and bottom parts of the search window, the higher the probability that a training well marker exist at the search window position along the training well trajectory.

(ii) Neural network strata-shapes estimator, which is a neural network classifier that is trained to detect one or more pre-determined curve shapes. In one or more embodiments, the pre-determined curve shapes are statistically determined based on similar curve shapes that are commonly found in geological strata logs. For example, the similar curve shapes are found in historical well logs and represent a particular type of geological strata

(iii) Clustering, which is based on subdividing all training well logs into well log sections and clustering similar well log sections using a clustering algorithm based on a pre-determined similarity measure.

In Step 232, the training well probability curves for each training well are aggregated to generate a training well summary probability curve for the corresponding training well. In one or more embodiments, the training well summary probability curve is based on the simple sum of all resulting probability curves from all algorithms for all well logs of the training well.

In Step 233, maximum values of each training well summary probability curve are determined to identify training well markers for the corresponding training well. Specifically, the training well markers are inserted into the training well log at the locations along the training well trajectory where these maximum values occur. In one or more embodiments, the training well markers of each training well form a training well marker sequence corresponding to sequential boundaries in a stratigraphic sequence intercepted by the training well.

In one or more embodiments, the aforementioned maximum values are determined based on a pre-determined threshold. In other words, any probability curve value exceeding the pre-determined threshold is considered as a maximum value. In one or more embodiments, the maximum values are determined using peak detection based on probability curve derivatives. In other words, any local maximum of probability curve value based on first and second derivatives of the probability curve is considered as a maximum value.

FIG. 2.3 depicts an example method for propagating training well markers to generate target well markers in accordance with one or more embodiments. In particular, the principle of the “sliding window” is used to propagate a training well marker onto a target well log. In one or more embodiments, well log values in a search window (or search interval) surrounding each training well marker are extracted to form a training well log pattern. For example, the search window may be defined by a pre-determined vertical thickness, such as half of the average horizon thickness on training wells. Accordingly, the training well log pattern is stepped through the target well log, computing the similarity to a well log interval (referred to as the sliding window) of the target well.

Initially in Step 241, for a pair of target well and training well, a similarity measure between a sliding window in the target well log and a search interval surrounding a training well marker in the training well log is computed. Specifically, the sliding window is a pre-determined depth range of the target well, and the search interval is a pre-determined depth range of the training well. For each training well marker inserted in the training well log, the sliding window is slid through the target well log by incrementing a starting point of the depth range based on a pre-determined depth increment. Accordingly, the similarity measure is computed for each incremented depth range for detecting any match between a portion of the target well log and a portion of the training well log. In particular, the portion of the target well log corresponds to a particular incremented depth range of the sliding window, and the portion of the training well log corresponds to the search interval of a particular training well marker. In one or more embodiments, the similarity measure represents a level of cross-correlation between the sliding window defined portion of the target well log and the search interval defined portion of the training well log. The higher the cross-correlation level is, the higher the probability that the particular training well marker surrounded by the search interval is to be propagated onto the particular incremented depth range of the sliding window in the target well log.

In one or more embodiments, the similarity measure is computed based on an Euclidian N-dimensional distance. Specifically, the sliding window defined portion of the target well log and the search interval defined portion of the training well log are each represented by a vector of N—number of log samples. Accordingly, the similarity measure is computed as the Euclidian N-dimensional distance between two points representing these two vectors in a N-dimensional space. In one or more embodiments, the similarity measure is inversely proportional to the Euclidian N-dimensional distance. In other words, the less the distance between the two vectors, the higher the similarity measure will be.

In one or more embodiments, the similarity measure is computed using a Dynamic Time Warping (DTW) algorithm. Specifically, the target well log and/or the training well log are warped (i.e., contracted or expanded) non-linearly along respective depth scales prior to applying the sliding window and/or the search interval described above to compute the similarity measure. In one or more embodiments, the similarity measure is computed based on a minimal sum of the DTW cost matrix path. In particular, the less the summary cost of this path is, the higher the similarity measure will be.

In one or more embodiments, the similarity measure is computed using power spectrum analysis. Specifically, frequency domain representations (i.e., power spectrums) of the sliding window defined portion of the target well log and the search interval defined portion of the training well log are obtained using Fast Fourier Transform. The higher level of similarity between the two power spectrums, the higher the similarity measure will be. In other words, if the two power spectrum are similar, the sliding window defined portion of the target well log and the search interval defined portion of the training well log are considered as similar.

In one or more embodiments, the similarity measure is computed using a neural network marker classifier. Specifically, a neural network is trained to detect marker shapes found in the search interval of the training well log. Then the sliding window defined portion of the target well log is inputted to the neural network to generate the similarity measure.

In one or more embodiments, the similarity measure is computed using time series statistical analysis. Specifically, a set of statistical parameters (e.g., math expectation, variance, standard deviation, etc.) is computed for each of the sliding window defined portion of the target well log and the search interval defined portion of the training well log. The closer the values of these two sets of statistical parameters, the higher the similarity measure will be.

In one or more embodiments, pre-determined constraints are used to guide the propagation of the training well markers.

In one or more embodiments, the sliding window is constrained between key markers. For example, the search interval with the extracted horizon values from the training well is only compared to the sliding window positioned between the constrained horizons in the target well log.

In one or more embodiments, the previously identified base horizon, top horizon, or seismic horizon is used as a guide for the training well marker propagation. For example, such a horizon may be parallel shifted to adjust a propagating training well marker. Specifically, the point where this shifted horizon intersects the target well is considered as having a high probability of target well marker presence.

In one or more embodiments, a structural geological map (e.g., a thickness map) is used as a guide for training well marker propagation. For example, a trend horizon for an unknown marker is calculated using the structural geological map and then a search is performed as described before for trend horizon.

In one or more embodiments, the matching procedure described above is repeated for each training well marker of each of the training wells.

In Step 242, in response to the similarity measure meeting a pre-determined criterion (e.g., exceeding a minimum threshold), the sliding window defined portion of the target well log and the search interval defined portion of the training well log are considered to be a match. Accordingly, a portion of a training well probability curve corresponding to the search interval is used to estimate a portion of a target well probability curve corresponding to the sliding window.

In Step 243, a target well probability curve is computed based on all matches found as the sliding window traverses the entire target well log. During the sliding window traversal, multiple portions of the target well probability curve, estimated based on matches to the search intervals surrounding various training well markers, are combined into the target well probability curve. In one or more embodiments, one target well probability curve is computed using the training well summary probability curve of each of the training wells. Accordingly, multiple target well probability curves are obtained from all of the training well logs. In one or more embodiments, one target well probability curve is computed using each of the training well probability curves (based on the aforementioned different algorithms) of each of the training wells.

In Step 244, multiple target well probability curves estimated from all of the training well logs are aggregated to generate a target well summary probability curve. Specifically, the target well summary probability curve estimates the probability of a sequence boundary intercepting the target well along its trajectory. In one or more embodiments, the aggregation is based on a weighed formula where the weight assigned to each of the target well probability curves is based on the inter-well physical distance between the target well and the training well used to compute the target well probability curve.

In Step 245, maximum values of the target well summary probability curve are determined to identify target well markers for the target well. Specifically, the target well markers are inserted into the target well log at the locations along the target well trajectory where these maximum values occur. In one or more embodiments, the maximum values are determined based on a pre-determined threshold. In other words, any probability curve value exceeding the pre-determined threshold is considered as a maximum value. In one or more embodiments, the maximum values are determined using peak detections based on probability curve derivatives. In other words, any local maximum of probability curve values based on first and second derivatives of the probability curve is considered as a maximum value.

As noted above, in one or more embodiments, one target well probability curve is computed using each of the training well probability curves (based on the aforementioned different algorithms) of each of the training wells. In such embodiments, target well summary probability curves from all algorithms are compared and the highest probability curve value among them is used to define the target well marker. The remaining lower probability curve values among them are considered as alternative correlations. In one or more embodiments, these alternative correlations can be selected by a user for manual corrections to supercede the automatically defined target well marker.

The workflow described in FIGS. 2.1, 2.2, and 2.3 above can be run as a single workflow for all the markers selected or can be run in a sequential order by applying stratigraphic rules for the markers. These rules include (i) the level of sequence boundary to limit search of possible positions of the current marker on the target well by spatial position of the level of the user-given sequence boundary, and (ii) the stratigraphic relationship with the lower/upper horizon (e.g., eroding, agradating, onlapping, downlapping) to limit search of possible positions of the current marker on the target well based on stratigraphic relationships with lower or upper horizon. For example, “eroding upper horizon” will limit search top position by upper horizon.

FIGS. 3.1, 3.2, 3.3, 3.4, and 3.5 depict an example of identifying geological formation depth structure using well log data in accordance with one or more embodiments.

As noted above, FIG. 3.1 shows an example screenshot A (310) depicting multiple wells associated with multiple well logs containing geologic records of a succession of geologic intervals.

FIG. 3.2 shows an example screenshot B (320) depicting a training well marker sequence inserted in each of the multiple training well logs to identify boundaries of the succession of geologic intervals shown in FIG. 3.1. As shown in FIG. 3.2, the example screenshot B (320) includes several training well logs (e.g., training well log (321)), which correspond to the training wells shown in FIG. 3.1 above. For example, the training well log (321) corresponds to the well (302) and is annotated with training well markers forming the training well marker sequence (322). Specifically, the training well marker sequence (322) identifies boundaries (e.g., boundary (308)) of the geologic intervals (303) intercepted by the well (302) shown in FIG. 3.1.

Further as shown in FIG. 3.2, all of the training well logs are annotated with respective training well marker sequences that are correlated, as indicated by the training well log correlations (323). Specifically, the training well log correlation (324) indicates how a particular set of correlated training well markers are inserted into separate training well logs at different depths representing how these training wells intercept the geologic intervals (303) at different well locations as shown in FIG. 3.1.

FIG. 3.3 shows an example screenshot C (330) depicting the training well markers of the well (302) propagated onto the target well log (304-1) of the target well (304) shown in FIG. 3.2. As shown in FIG. 3.3, the example screenshot C (330) includes the training well log (321) where the search interval (333) surrounds the training well marker (335) to specify the search interval defined portion of training well log (334). As noted above, the training well log (321) corresponds to the well (302) shown in FIG. 3.1, which in turn may correspond to the wellbore (103) and the wireline log (108) shown in FIG. 1. In particular, the training well marker (335) may be the same as the marker (108-1) shown in FIG. 1.

Further as shown in FIG. 3.3, the target well log (304-1) corresponds to the target well (304) shown in FIG. 3.1 and contains the sliding window (336) specifying the sliding window defined portion of the target well log (337). As described in reference to FIG. 2.3 above, the similarity measure between the search interval defined portion of the training well log (334) and the sliding window defined portion of the target well log (337) is computed using the similarity measure formula (341), which is based on an Euclidian N-dimensional distance. The computed similarity measure is then used to construct the target well probability curve (332) as the sliding window (336) traverses the target well log (304-1), as indicated by the arrow (340). In particular, the target well probability curve (332) is computed for the target well (304) based on the training well log (321). As described in reference to FIG. 2.3 above, additional target well probability curves for the target well (304) are also computed based on the training well logs of other training wells using the similarity measure formula (341). All these target well probability curves are then aggregated into a target well summary probability curve for the target well (304). In addition, the maxima (339) of the target well probability curve (332) is identified and used to determine the target well marker (304-2).

FIG. 3.4 shows an example screenshot D (340) depicting the target well marker sequence (341) inserted into the target well log (304-1). Specifically, the target well marker sequence (341) is propagated onto the target well log (304-1) from the training well marker sequence (322) of the training well log (321) shown in FIG. 3.2. As described in reference to FIG. 2.3 above, additional target well marker sequences for the target well (304) are also computed based on the training well marker sequences of other training wells in a similar fashion. All these target well marker sequences are then summarized into a summarized target well marker sequence for the target well (304).

FIG. 3.5 shows an example of adjusting the target well markers to eliminate a missing target well interval. As shown in FIG. 3.5, well log A (351) and well log B (352) are inserted with markers defining the geological intervals (e.g., geological interval A (353)) intercepted by two corresponding wells (not shown). For example, one or more of the well log A (351) and well log B (352) may be a training well log or a target well log. In addition, the markers defining the geological intervals of one or more of the well log A (351) and well log B (352) may be generated using the method described in reference to FIGS. 2.1-2.3 above.

Further as shown in FIG. 3.5, the correlation matrix (350) is computed by calculating a correlation measure between each pair of intervals between the well log A (351) and well log B (352). As shown, the vertical dimension of the correlation matrix (350) corresponds to the well log A (351) and is labeled well A interval sequence (354), which includes five intervals A, B, C, D, and E. Similarly, the horizontal dimension of the correlation matrix (350) corresponds to the well log B (352) and is labeled well B interval sequence (355), which includes four intervals A1, B1, D1, and E1. Each of the matrix elements of the correlation matrix (350) represents a similarity measure between intervals of the well log A (351) and well log B (352). In one or more embodiments, each matrix element in the correlation matrix (350) is calculated based on the different similarity measures described in reference to FIG. 2.3 above. For example, each matrix element shown in FIG. 3.5 may be a sum of all these calculated similarity measures. In one or more embodiments, the thickness of intervals is taken into account, (e.g., intervals with similar thickness are considered more similar). As shown in FIGS. 3.5, H, M, and L represents high similarity, medium similarity, and low similarity, respectively. For example, the similarity measure (357) indicates that the interval A of the well log A (351) and the interval A1 of the well log B (352) are highly similar.

Based on the similarity measures calculated above, several matrix elements marked H or M connect to form the correlated intervals (356). A jog in this otherwise straight line of the correlated intervals (356) indicates a missing interval (358). In one or more embodiments, direct fault markers are automatically created at the location of the missing interval (358). For example, the direct fault markers may define an interval C1 (not shown) to be inserted in-between the intervals B1 and D1 in the well B interval sequence (355). Similarly, in the case of repeated intervals, an automatic reverse fault marker is created at the base of the repeated interval.

Although the example shown in FIG. 3.5 is described using a single pair of two wells, multiple well pairs in a field or a region of interest may be analyzed to eliminate missing or repeated intervals as described above. After accounting for unconformities and faulting, markers are resampled and the final correlation scheme is obtained. After making manual corrections, accounting for faulting and unconformities, or changing places of some markers, automatic well correlation procedure could be run once again, with new data correlation data obtained, to increase a confidence measure of the correlation results with each iteration.

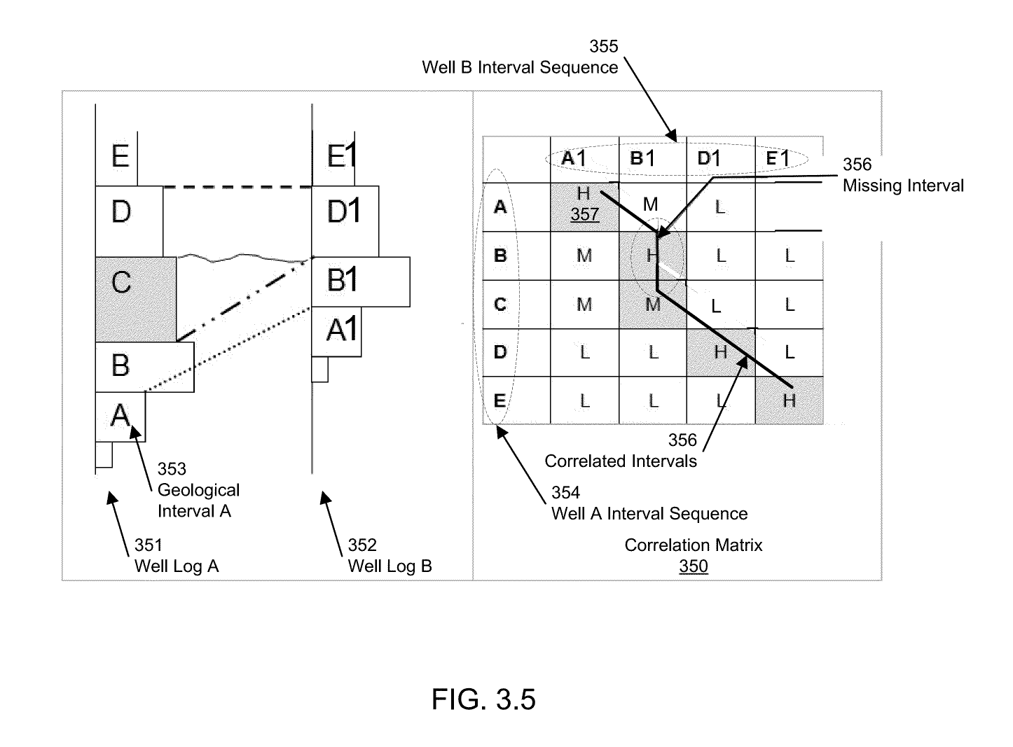

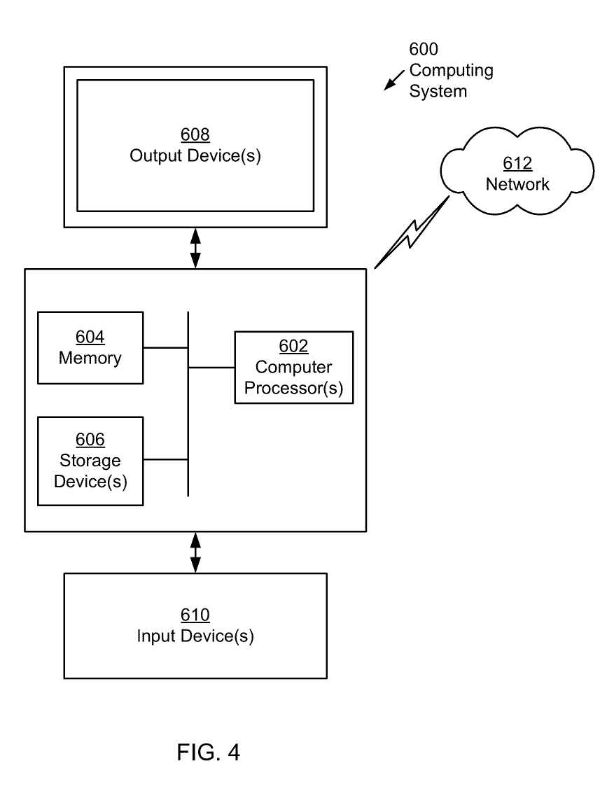

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor. The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (600) may be located at a remote location and connected to the other elements over a network (612). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for performing a field operation of a field having a subterranean formation, the method comprising:
analyzing, by a computer processor, a plurality of training well logs of a plurality of training wells in the field to generate a plurality of training well markers, wherein the plurality of training well markers identify where the plurality of training wells intercept a plurality of geologic interval boundaries in the subterranean formation;
propagating, by the computer processor and onto a target well log of a target well in the field, the plurality of training well markers to generate a plurality of target well markers, wherein the plurality of target well markers identify where the target well intercepts the plurality of geologic interval boundaries; and
performing the field operation based at least on identifying where the target well intercepts the plurality of geologic interval boundaries.

2. The method of claim 1, further comprising:
assigning weights to a plurality of wells in the field, wherein the plurality of wells comprises a particular well assigned a weight that is based on a distance from the particular well to at least one selected from a group consisting of an adjacent well and a geological structure; and
selecting the plurality of training wells from the plurality of wells based on the plurality of weights.

3. The method of claim 1, wherein the plurality of training well markers are generated by:
selecting a training well;
analyzing a training well log corresponding to the training well to generate a plurality of training well probability curves, wherein each of the plurality of training well probability curves is generated using one of a plurality of pre-determined algorithms and estimates a probability of a sequence boundary along a training well trajectory of the training well;
aggregating the plurality of training well probability curves to generate a training well summary probability curve for the training well; and
determining a plurality of maximum values of the training well summary probability curve,
wherein the plurality of training well markers are generated for the training well based at least on the plurality of maximum values.

4. The method of claim 3, wherein the plurality of pre-determined algorithms comprises a neural network classifier, wherein analyzing the training well log using the neural network classifier comprises:
training the neural network classifier based on a statistically defined curve shape in a plurality of historical well logs that represents a pre-determined geological strata; and
detecting the statistically defined curve shape in the training well log,
wherein at least one of the plurality of maximum values corresponds to the statistically defined curve shape detected in the training well log.

5. The method of claim 3, wherein generating the plurality of target well markers comprises:
computing a plurality of target well probability curves corresponding to the plurality of target wells, wherein a target well probability curve of the plurality of target well probability curves is computed using the plurality of training well probability curves associated with the training well and is computed based on a similarity measure between the target well log and the training well log of the training well; and
aggregating the plurality of target well probability curves to generate a target well summary probability curve,
wherein the target well summary probability curve estimates the probability of the sequence boundary along a target well trajectory of the target well, and
wherein the plurality of target well markers is generated based at least on the target well summary probability curve.

6. The method of claim 5, wherein computing the target well probability curve comprises:
computing the similarity measure between a sliding window in the target well log and a search interval surrounding a training well marker in the training well log of the training well; and
estimating, in response to the similarity measure meeting a pre-determined criterion, a portion of the target well probability curve using the plurality of training well probability curves based on the search interval.

7. The method of claim 5, wherein the similarity measure is computed using at least one selected from a group consisting of dynamic time warping, power spectrum analysis, and a geometrical extrapolation and sedimentary model.

8. The method of claim 1, further comprising:
identifying a plurality of target well intervals in the target well log based on the plurality of target well markers;
correlating the plurality of target well intervals in the target well log and a plurality of training well intervals in at least one of the plurality of training wells to identify at least one anomaly selected from a group consisting of a missing target well interval and a duplicative target well interval; and
adjusting in response to the correlating, the plurality of target well markers to eliminate the at least one anomaly.

9. A surface unit for performing a field operation of a field having a subterranean formation, the surface unit comprising:
a computer comprising a computer processor and memory;
a training well marker generator stored in the memory, executing on the computer processor, and configured to analyze a plurality of training well logs of a plurality of training wells in the field to generate a plurality of training well markers, wherein the plurality of training well markers identify where the plurality of training wells intercept a plurality of geologic interval boundaries in the subterranean formation;
a training well marker propagator stored in the memory, executing on the computer processor, and configured to propagate, onto a target well log of a target well in the field, the plurality of training well markers to generate a plurality of target well markers, wherein the plurality of target well markers identify where the target well intercepts the plurality of geologic interval boundaries; and
a repository for storing the plurality of training well logs, the target well log, the plurality of training well markers, and the plurality of target well markers,
wherein the field operation is performed based at least on identifying where the target well intercepts the plurality of geologic interval boundaries.

10. The surface unit of claim 9, further comprising a training well selector stored in the memory, executing on the computer processor, and configured to
assign weights to a plurality of wells in the field, wherein the plurality of wells comprises a particular well assigned a weight that is based on a distance from the particular well to at least one selected from a group consisting of an adjacent well and a geological structure; and
select the plurality of training wells from the plurality of wells based on the plurality of weights.

11. The surface unit of claim 9, wherein the plurality of training well markers are generated by:
selecting a training well;
analyzing a training well log corresponding to the training well to generate a plurality of training well probability curves, wherein each of the plurality of training well probability curves is generated using one of a plurality of pre-determined algorithms and estimates a probability of a sequence boundary along a training well trajectory of the training well;
aggregating the plurality of training well probability curves to generate a training well summary probability curve for the training well; and
determining a plurality of maximum values of the training well summary probability curve,
wherein the plurality of training well markers are generated for the training well based at least on the plurality of maximum values.

12. The surface unit of claim 11, wherein the plurality of pre-determined algorithms comprises a neural network classifier, wherein analyzing the training well log using the neural network classifier comprises:
training the neural network classifier based on a statistically defined curve shape in a plurality of historical well logs that represents a pre-determined geological strata; and
detecting the statistically defined curve shape in the training well log,
wherein at least one of the plurality of maximum values corresponds to the statistically defined curve shape detected in the training well log.

13. The surface unit of claim 11, wherein the plurality of target well markers are generated by:
computing a plurality of target well probability curves corresponding to the plurality of target wells, wherein a target well probability curve of the plurality of target well probability curves is computed using the plurality of training well probability curves associated with the training well and is computed based on a similarity measure between the target well log and the training well log of the training well; and
aggregating the plurality of target well probability curves to generate a target well summary probability curve,
wherein the target well summary probability curve estimates the probability of the sequence boundary along a target well trajectory of the target well, and
wherein the plurality of target well markers is generated based at least on the target well summary probability curve.

14. The surface unit of claim 13, wherein computing the target well probability curve comprises:
computing the similarity measure between a sliding window in the target well log and a search interval surrounding a training well marker in the training well log of the training well; and
estimating, in response to the similarity measure meeting a pre-determined criterion, a portion of the target well probability curve using the plurality of training well probability curves based on the search interval.

15. The surface unit of claim 13, wherein the similarity measure is computed using at least one selected from a group consisting of dynamic time warping, power spectrum analysis, and a geometrical extrapolation and sedimentary model.

16. The surface unit of claim 9, further comprising an interval analyzer stored in the memory, executing on the computer processor, and configured to:
identify a plurality of target well intervals in the target well log based on the plurality of target well markers;
correlate the plurality of target well intervals in the target well log and a plurality of training well intervals in at least one of the plurality of training wells to identify at least one anomaly selected from a group consisting of a missing target well interval and a duplicative target well interval; and
adjust in response to the correlating, the plurality of target well markers to eliminate the at least one anomaly.

17. A non-transitory computer readable medium storing instructions for performing a field operation of a field having a subterranean formation, the instructions when executed causing a computer processor to:
analyze a plurality of training well logs of a plurality of training wells in the field to generate a plurality of training well markers, wherein the plurality of training well markers identify where the plurality of training wells intercept a plurality of geologic interval boundaries in the subterranean formation;
propagate, onto a target well log of a target well in the field, the plurality of training well markers to generate a plurality of target well markers, wherein the plurality of target well markers identify where the target well intercepts the plurality of geologic interval boundaries; and
perform the field operation based at least on identifying where the target well intercepts the plurality of geologic interval boundaries.

18. The non-transitory computer readable medium of claim 17, further comprising instructions when executed causing the computer processor to:
assign weights to a plurality of wells in the field, wherein the plurality of wells comprises a particular well assigned a weight that is based on a distance from the particular well to at least one selected from a group consisting of an adjacent well and a geological structure; and
select the plurality of training wells from the plurality of wells based on the plurality of weights.

19. The non-transitory computer readable medium of claim 17, wherein the plurality of training well markers are generated by:
selecting a training well;
analyzing a training well log corresponding to the training well to generate a plurality of training well probability curves, wherein each of the plurality of training well probability curves is generated using one of a plurality of pre-determined algorithms and estimates a probability of a sequence boundary along a training well trajectory of the training well;
aggregating the plurality of training well probability curves to generate a training well summary probability curve for the training well; and
determining a plurality of maximum values of the training well summary probability curve,
wherein the plurality of training well markers are generated for the training well based at least on the plurality of maximum values.

20. The non-transitory computer readable medium of claim 19, wherein the plurality of target well markers are generated by:
computing a plurality of target well probability curves corresponding to the plurality of target wells, wherein a target well probability curve of the plurality of target well probability curves is computed using the plurality of training well probability curves associated with the training well and is computed based on a similarity measure between the target well log and the training well log of the training well; and
aggregating the plurality of target well probability curves to generate a target well summary probability curve,
wherein the target well summary probability curve estimates the probability of the sequence boundary along a target well trajectory of the target well, and
wherein the plurality of target well markers is generated based at least on the target well summary probability curve.
